(19) United States
(12) Patent Application Publication
(10) Pub. No.: US 2013/0075132 A1
(43) Pub. Date: Mar. 28, 2013

(54) ELECTRICAL COMPONENT

(71) Applicants: Kensuke Sasaki, Sagamihara-shi (JP); Kenta Suzuki, Zama-shi (JP); Tadashi Kasuya, Atsugi-shi (JP)

(72) Inventors: Kensuke Sasaki, Sagamihara-shi (JP); Kenta Suzuki, Zama-shi (JP); Tadashi Kasuya, Atsugi-shi (JP)

(73) Assignee: NISSAN MOTOR CO., LTD.

(21) Appl. No.: 13/703,213

(22) PCT Filed: May 31, 2011
(86) PCT No.: PCT/JP2011/003058

§ 371 Date: Dec. 10, 2012

(30) Foreign Application Priority Data
Jun. 11, 2010 (JP) 2010-133535
Mar. 16, 2011 (JP) 2011-057353

(51) Int. Cl. H01B 17/42

(52) U.S. Cl. CPC H01B 17/42
USPC 174/140 R

(57) ABSTRACT

A resistant body 13 is provided in a periphery of at least one of the current-carrying members 11 on a surface of the insulator 12. The resistant body 13 distributes a voltage applied to the surface of the insulator 12 between a pair of the current-carrying members 11 adjacent to each other, so that a potential difference distributed on the surface of the insulator 12 is set to a discharge starting voltage or less.

### TECHNICAL FIELD

The present invention relates to an electrical component having current-carrying members held by an insulator.

### BACKGROUND ART

Conventionally, various methods for improvement of insulation durability with regard to an electrical component such as a terminal block have been suggested. For example, PTL 1 discloses a method for forming a conductive glaze layer (resistant body) in a boundary region between an insulating glaze layer of an insulator main body, in which an electric field concentration is easily caused, and a cement material. According to this method, an electric field concentration can be reduced, thereby preventing an occurrence of a corona discharge and a radio influence voltage (RIV).

### CITATION LIST

### Patent Literature

PTL 1: Japanese Patent Application Laid-Open Publication No. H08-264052

### SUMMARY OF INVENTION

### Technical Problem

However, the method described in PTL 1 may not reduce an electric field so as not to start an electric discharge even if the resistant body is provided. As a result, an electric discharge from the surface of an insulator may not be reduced, and insulation durability of an electrical component may be decreased.

The present invention has been made in view of such a problem. It is an object of the present invention to improve insulation durability of an electrical component by suppressing an electric discharge from the surface of an insulator.

### Solution to Problem

In order to solve the above-mentioned problem, an electrical component of the present invention includes voltage distribution units provided at the peripheries of current-carrying members on the surface of an insulator. The voltage distribution units distribute a voltage applied to the surface of the insulator between a pair of current-carrying members adjacent to each other, so that a potential difference distributed on the surface of the insulator is set to a discharge starting voltage or less.

### Advantageous Effect of Invention

According to the present invention, a potential difference distributed on the surface of the insulator can be reduced to a discharge starting voltage or less due to the voltage distribution units provided at the peripheries of the current-carrying members. Therefore, an electric field adjacent to the current-carrying members can be reduced. Accordingly, an electric discharge caused on the surface of the insulator can be prevented, and therefore, insulation durability of the electrical component can be improved.

### BRIEF DESCRIPTION OF DRAWINGS

FIG. 1 is an explanatory diagram schematically showing a constitution of an electric motor 1 to which an electrical component 10 is applied.

FIG. 2(a) is a plan view showing a constitution of the electrical component 10 according to the first embodiment. FIG. 2(b) is a cross-sectional view taken along the lines passing through each center of a pair of current-carrying members 11 in FIG. 2(a).

FIG. 3(a) is an explanatory plan view showing a constitution of an electrical component 20 to be compared with the electrical component 10 shown in FIG. 2. FIG. 3(b) is a cross-sectional view taken along the lines passing through each center of a pair of current-carrying members 21 in FIG. 3(a). FIG. 3(c) is a graph showing a potential distribution taken along the lines passing through each center of the pair of the current-carrying members 21 in FIG. 3(a).

FIG. 4(a) is an explanatory plan view showing a constitution of an electrical component 20 to be compared with the electrical component 10 shown in FIG. 2. FIG. 4(b) is a cross-sectional view taken along the lines passing through each center of a pair of current-carrying members 21 in FIG. 4(a). FIG. 4(c) is a graph showing a potential distribution taken along the lines passing through each center of the pair of the current-carrying members 21 in FIG. 4(a).

FIG. 5(a) is an explanatory cross-sectional view showing an electric field reduction effect due to resistant bodies 13 of the electrical component 10. FIG. 5(b) is a graph showing a potential distribution taken along the lines passing through each center of the pair of the current-carrying members 11 in FIG. 5(a).

FIG. 6(a) is a plan view showing a constitution of a modified example of the electrical component 10 according to the first embodiment. FIG. 6(b) is a cross-sectional view taken along the lines passing through each center of a pair of current-carrying members 11 in FIG. 6(a).

FIG. 7(a) is a plan view showing a constitution of another modified example of the electrical component 10 according to the first embodiment. FIG. 7(b) is a cross-sectional view taken along the lines passing through each center of a pair of current-carrying members 11 in FIG. 7(a).

FIG. 8(a) is a plan view showing a constitution of still another modified example of the electrical component 10 according to the first embodiment. FIG. 8(b) is a cross-sectional view taken along the lines passing through each center of a pair of current-carrying members 11 in FIG. 8(a).

FIG. 9(a) is a plan view showing a constitution of the electrical component 10 according to the second embodiment. FIG. 9(b) is a cross-sectional view taken along the lines passing through each center of a pair of current-carrying members 11 in FIG. 9(a). FIG. 9(c) is a graph showing a potential distribution taken along the lines passing through each center of the pair of the current-carrying members 11 in FIG. 9(a).

FIG. 10(a) is a plan view showing a constitution of a modified example of the electrical component 10 according to the second embodiment. FIG. 10(b) is a cross-sectional view taken along the lines passing through each center of a pair of current-carrying members 11 in FIG. 10(a).

FIG. 11 is a plan view showing a constitution of another modified example of the electrical component 10 according to the second embodiment.

### DESCRIPTION OF EMBODIMENTS

### First embodiment

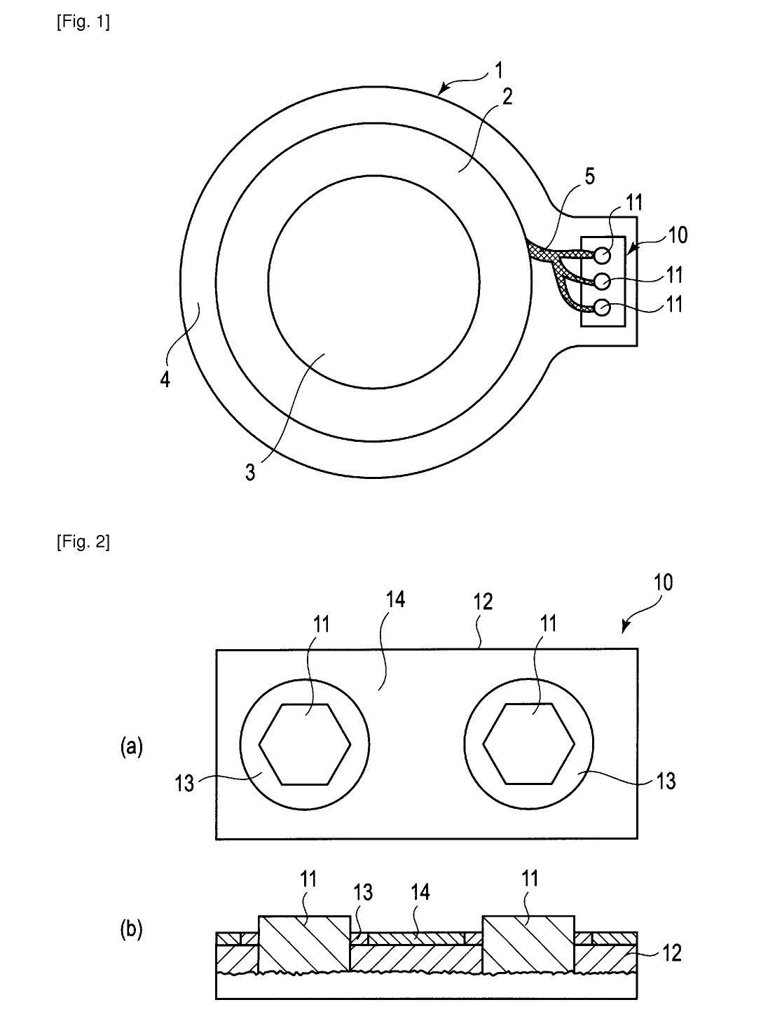

FIG. 1 is an explanatory diagram schematically showing a constitution of an electric motor 1 to which an electrical component 10 according to the present embodiment is applied. The electrical component 10 is connected to an external device not shown in the figure (for example, inverter) and the electric motor 1 via cables, so that the electrical component 10 functions as a terminal block to electrically connect the inverter and the electric motor 1 via the electrical component 10.

The electric motor 1 is a permanent magnet synchronous motor in which a plurality of phase windings (for example, three phase windings) connected in a star connection state centered on a neutral point are wound around a stator 2. The electric motor 1 includes the stator 2 having a ring shape in cross-section and a rotor (mover) 3 connected to a shaft not shown in the figure. The rotor 3 is provided in an inner periphery of the stator 2 via an air gap. The stator 2 and the rotor 3 are housed in a case 4, of which a part is provided with the electrical component 10 as a terminal block.

A coil lead wire 5 as a part of the respective phase windings wound around the stator 2 is connected to three current-carrying members (electrode terminals) 11 per phase provided in the electrical component 10. Each of current-carrying members are serving as current-carrying means. The respective current-carrying members 11 are connected to cables (not shown in the figure) connected to an outer portion of the case 4 to connect to the inverter, so that power corresponding to demand power is applied to the phase windings of each phase via the respective current-carrying members 11.

The electric motor 1 drives due to an interaction between a magnetic field that is generated by the supply of three-phase AC power to coils of each phase from the inverter via the electrical component 10 and a magnetic field that is generated by permanent magnet of the rotor. More specifically, in the electric motor 1, a magnetic circuit is composed of permanent magnet embedded in the rotor 3, a magnetic body (electromagnetic steel plate) composing the rotor 3 itself, and a magnetic body (electromagnetic steel plate) composing the stator 2. When magnetic flux from the permanent magnet and alternating magnetic flux generated due to current applied to the phase windings by inverter control pass through the magnetic circuit, torque is generated due to electromagnetic power, so as to rotate the rotor 3 and the shaft connected to the rotor 3.

FIG. 2 is an explanatory diagram showing a constitution of the electrical component 10 according to the present embodiment. The electrical component 10 is composed of the current-carrying members 11, an insulator 12 (serving as insulating means), and resistant bodies 13. In the present embodiment, the electrical component 10 is assumed to be a terminal block, and the electrical component 10 includes the three current-carrying members 11 corresponding to three phases as shown in FIG. 1. Although the following is an explanation of the electrical component 10 and mainly a pair of the current-carrying members 11 adjacent to each other as main parts for the sake of convenience, the similar consideration may be also applied to the remaining current-carrying member 11.

Each of the current-carrying members 11 is composed of a material having electrical conductivity, such as a metallic material, though which current passes. The respective current-carrying members 11 are integrated with the insulator 12 by a molding means such as insert molding. For example, nuts are molded in the insulator 12, and bolts are fixed to the nuts, so as to form the current-carrying members 11.

The insulator 12 is composed of an insulating material such as resin. The current-carrying members 11 are loaded in a metal mold, followed by filling the mold with resin and solidifying it, so that the insulator 12 is formed into a predetermined shape. The insulator 12 holds the respective current-carrying members 11 in an insulating state, while a part of the respective current-carrying members 11 protrudes from the surface.

The resistant bodies 13 are provided in the outer edge areas of the current-carrying members 11 on the surface of the insulator 12. More specifically, the resistant bodies 13 are provided on the surface of the insulator 12 to surround the peripheries including the outer edge areas of the current-carrying members 11. In other words, the resistant bodies 13 are provided in predetermined ranges from the edges of the current-carrying members 11 toward a radial direction to surround the current-carrying members 11. According to the present embodiment, the resistant bodies 13 are configured to have a circular outer edge shape. The resistant bodies 13 adhere to the surface of the insulator 12 by an adhesive agent, for example, so as to be fixed to the surface of the insulator 12. Alternatively, the resistant bodies 13 may be integrated with the insulator 12 by insert molding in a similar manner to the current-carrying members 11, so as to be fixed to the surface of the insulator 12.

In the electrical component 10, an ionic contaminant 14 scattering in a surrounding environment associated with the use of the electrical component 10 adheres to the surface of the insulator 12. The resistant bodies 13 distribute a voltage applied to the surface of the insulator 12 via the ionic contaminant 14, so as to function to reduce an electric field adjacent to the current-carrying members 11. Particularly in the present embodiment, in order to obtain the electric field reduction effect appropriately, the resistant bodies 13 are composed of a single arbitrary material or a composite material so as to have a predetermined resistant value R. The following is a specific explanation of the resistant bodies 13.

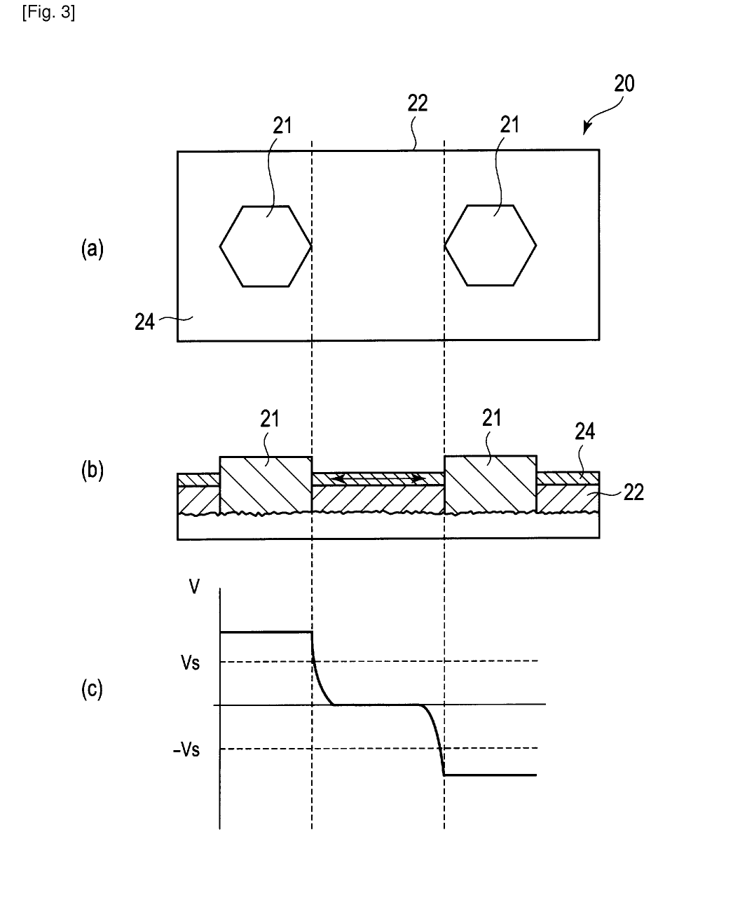

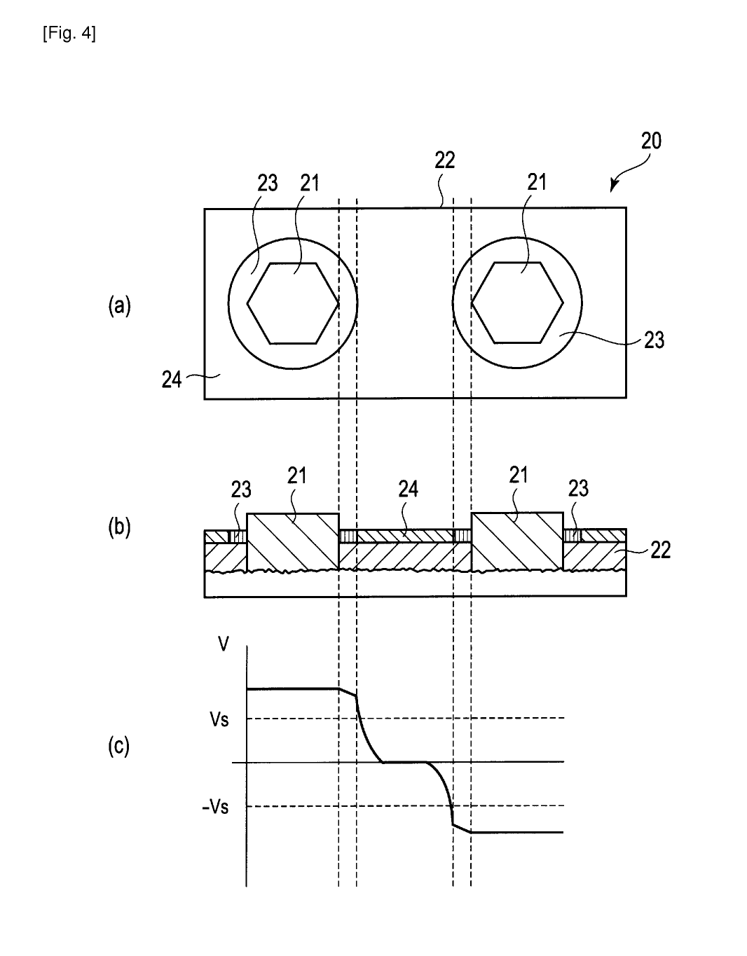

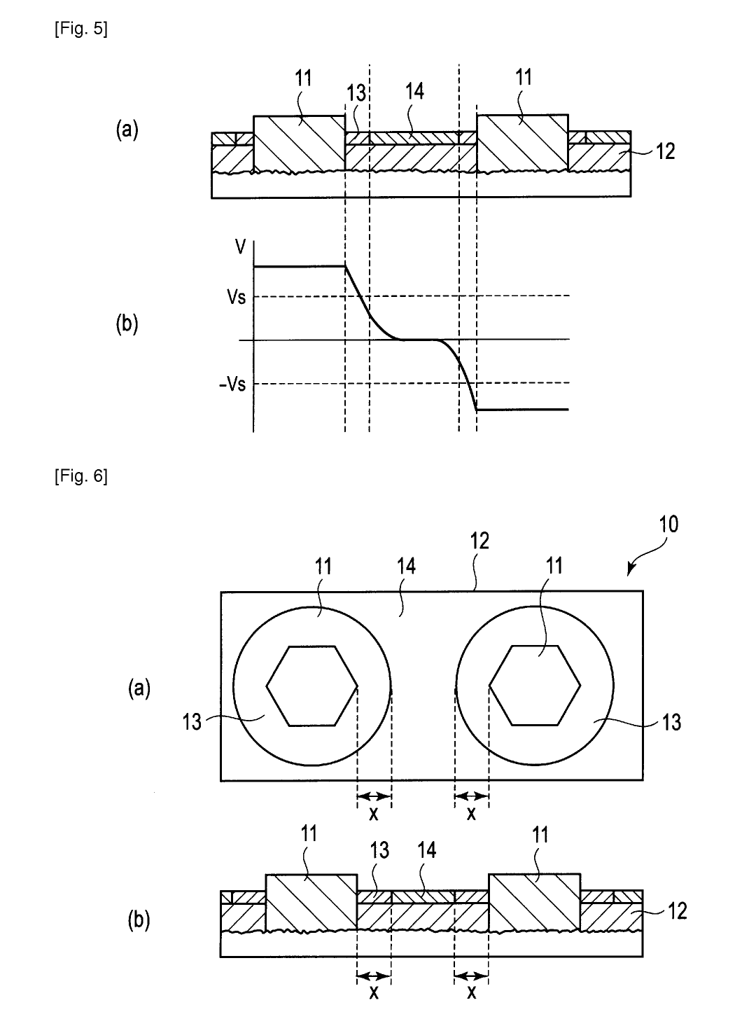

The electric field reduction effect due to the resistant bodies 13 provided in the electrical component 10 according to the present embodiment will be explained with reference to FIGS. 3 to 5. FIGS. 3 and 4 are explanatory diagrams of an electrical component 20 to be compared with the electrical component 10 shown in FIG. 2. FIG. 5 is an explanatory diagram of the electric field reduction effect due to the resistant bodies 13 of the electrical component 10 according to the present embodiment.

First, the state in which the electrical component 20 is composed of current-carrying members 21 and an insulator 22 will be discussed. An ionic contaminant 24 scattering in a surrounding environment associated with the use of the electrical component 20 adheres to the surface of the insulator 22. The ionic contaminant 24 absorbs moisture and deliquesces because of an increase of environmental humidity, thereby achieving electrical conductivity. In the constitution in which a pair of the current-carrying members 21 are provided to face each other on the surface of the insulator 22, a leakage current flows in the surface of the insulator 22 via the ionic contaminant 24 that has absorbed moisture and deliquesced (refer to an arrow shown in FIG. 3(b)). As shown in FIG. 3(c), a voltage applied to the surface of the insulator 22 is concentrated in the areas adjacent to the current-carrying members 21. As a result, an electric discharge caused on the surface of the insulator 22 is concentrated in the areas adjacent to the current-carrying members 21.

In order to reduce an electric field adjacent to the current-carrying members 21, resistant bodies 23 are provided in the outer edge areas of the current-carrying members 21 on the surface of the insulator 22 as shown in FIGS. 4(a) and 4(b). As shown in FIG. 4(c), the resistant bodies 23 partially distribute a voltage, so that the voltage applied to the peripheries of the resistant bodies 23 on the surface of the insulator 22 (hereinafter, referred to as “periphery applied voltage”) is decreased. Accordingly, the electric field adjacent to the current-carrying members 21 is reduced equivalently.

However, even if the resistant bodies 23 are simply provided in the outer edge areas of the current-carrying members 21, the periphery applied voltage is required to be reduced to a discharge starting voltage Vs or less in order to obtain the electric field reduction effect sufficient to suppress an aerial discharge. Thus, the resistant bodies 13 in the electrical component 10 according to the present embodiment is configured to obtain the electric field reduction effect sufficient to suppress an aerial discharge. Namely, the resistant value of the resistant bodies 13 is determined by comparing the discharge starting voltage Vs with the applied voltage between the pair of the current-carrying members 21 adjacent to each other, followed by calculating a voltage value necessary to be distributed by the resistant bodies 13, and further based on the calculated voltage value, a type and amount of the ionic contaminant, and a leakage current defined according to environmental humidity.

The following is a specific explanation of the resistant bodies 13 according to the present embodiment. With reference to FIG. 5, in the cross-section perpendicular to a direction of a leakage current flowing in the ionic contaminant 14, a leakage current i per unit area is derived by the following formula.

$$i = \frac{n \times F \times c \times \sqrt{D}}{\sqrt{π \times t}} \qquad [ Math . 1 ]$$

In the formula, n represents a valence of ion caused by moisture absorption and deliquescence by the contaminant, and F represents a Faraday constant. In addition, c represents a concentration of a contaminant aqueous solution having water vapor pressure identical to a surrounding atmosphere, and D represents a diffusion coefficient of ion caused by moisture absorption and deliquescence by the contaminant. Further, t represents a current-carrying time.

The leakage current i tends to be saturated having a constant value associated with a continuation of current conduction. In this case, if a thickness of a diffusion layer is defined as a proportional constant ka, the mathematical formula 1 may be replaced with the following formula.

i=ka×n×F×c×D [Math.2]

When a contaminant adhesion amount P of the insulator 12 per unit surface area is used, a thickness of an aqueous solution generated by moisture absorption and deliquescence by the contaminant is derived by the following formula.

$$R = \frac{\frac{V}{2} - {V}_{S}}{I} \qquad [ Math . 5 ]$$

Thus, a leakage current I per unit length along a direction of an electric field at the peripheries of the current-carrying members 11 is determined by the following formula, regardless of an applied voltage.

I=i×t [Math.4]

Therefore, the resistant value R of the resistant bodies 13 per unit length along the direction of the electric field at the peripheries of the current-carrying members 11 that is necessary to suppress an electric discharge caused on the surface of the insulator 12 is derived by the following formula by use of the voltage V applied between the current-carrying members 11.

$$t = \frac{p}{c} \qquad [ Math . 3 ]$$

In the mathematical formula, Vs represents a discharge starting limit voltage by a Paschen's law, and is approximately 300 V under a normal temperature atmospheric pressure environment.

According to the present embodiment, as described above, the resistant bodies 13 are provided at the peripheries of the current-carrying members 11 on the surface of the insulator 12. The resistant bodies 13 have the resistant value R including a condition in which the voltage applied to the peripheries of the resistant bodies 13 (periphery applied voltage) is set to the discharge starting voltage Vs or less on the surface of the insulator 12.

According to such a constitution, the resistant bodies 13 having the resistant value R to be appropriately set are provided at the peripheries of the current-carrying members 11 on the surface of the insulator 12. Due to the resistant bodies 13, the prescribed object to reduce the periphery applied voltage to the discharge starting voltage Vs or less can be achieved, which may not be achieved in the case in which the resistant bodies are simply provided at the peripheries of the current-carrying members 11 (refer to FIG. 5(b)). Therefore, the electric field reduction effect adjacent to the current-carrying members 11 can be obtained sufficiently. Accordingly, an electric discharge caused on the surface of the insulator 12 can be suppressed effectively, and therefore, the improvement of insulation durability of the electrical component 10 can be achieved.

In the present embodiment, the resistant bodies 13 are provided on the surface of the insulator 12 so as to surround the peripheries including the outer edge areas of the current-carrying members 11. According to such a constitution, the resistant bodies 13 distribute the voltage applied to the surface of the insulator 12 between the pair of current-carrying members 11 adjacent to each other, so that a potential difference (periphery applied voltage) distributed on the surface of the insulator is set to the discharge starting voltage Vs or less. Namely, the resistant bodies 13 function as a voltage distribution unit (voltage distribution means), so as to sufficiently obtain the electric field reduction effect, and further effectively suppress an electric discharge caused on the surface of the insulator 12.

The following is an explanation of a modified example of the resistant bodies 13 of the electrical component 10 according to the first embodiment. In the explanation of the modified example, the constitutions identical to the above-described embodiment will refer to the same reference numerals, and the explanations thereof will not be repeated. The differences from the above-described embodiment will be mainly explained below.

### First Modified Example

FIG. 6 is an explanatory diagram schematically showing the modified example of the electrical component 10 according to the first embodiment. In the present modified example, range widths x (lengths in a radial direction) of the resistant bodies 13 are set appropriately. More specifically, targeting the shortest distance between the pair of the current-carrying members 11 adjacent to each other, range widths in which the periphery applied voltage is set to the discharge starting voltage Vs or less are determined, thereby defining the determined range widths as the range widths x of the resistant bodies 13.

The following is a specific explanation of a determination method of the range widths x of the resistant bodies 13. More specifically, the range widths x of the resistant bodies 13 are indicated by use of a Paschen's law based on the relation between the voltage V applied between the current-carrying members 11 and the discharge starting limit voltage Vs by a Paschen's law (refer to the mathematical formula 6).

$$\frac{V}{2} - {V}_{S} = \frac{B \times p \times x}{ln \frac{A \times p \times x}{ln ( 1 + \frac{1}{Gma} )}} \qquad [ Math . 6 ]$$

In the formula, p represents atmospheric pressure, and A and B represent constants to determine a collisional ionization coefficient of gas. In addition, Gma represents a secondary electron emission coefficient.

According to the present example, as described above, the range widths are determined by targeting the shortest distance between the pair of the current-carrying members 11 adjacent to each other, so that the range widths x of the resistant bodies 13 can be set to the minimum values. Accordingly, a growth in size of the electrical component 10 can be suppressed while the sufficient discharge prevention effect is achieved.

### Second Modified Example

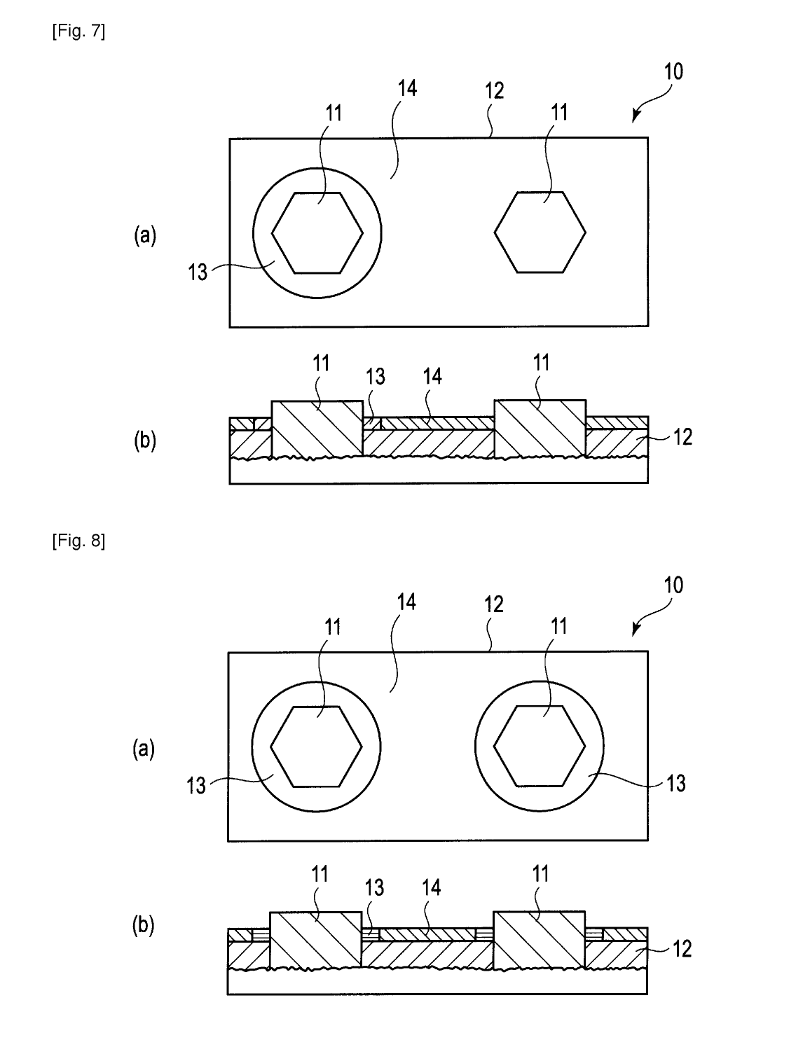

FIG. 7 is an explanatory diagram schematically showing another modified example of the electrical component 10 according to the first embodiment. In the present modified example, only one of the pair of the current-carrying members 11 is provided with the resistant body 13. One of the pair of the current-carrying members 11 to be provided with the resistant body 13 is preferably the current-carrying member 11 at a high potential side. Such a layout is based on the knowledge that an electric discharge is easily caused at the current-carrying member 11 at a high potential side compared with the current-carrying member 11 at a low potential side.

In other words, according to the present example, since only one of the current-carrying members 11 is provided with the resistant body 13, an increase in cost associated with an increase in number of components can be prevented. In addition, since the resistant body 13 is provided at the current-carrying member 11 at a high potential side at which an electric discharge is particularly easily caused, the sufficient discharge prevention effect can be obtained. Accordingly, reliability with regard to insulation durability of the electrical component 10 can be improved.

In the case of a terminal block for connecting three phases, the current-carrying member 11 at a high potential side of the three current-carrying members 11 varies periodically. Therefore, the present modified example is effective with respect to the electrical component 10 in which a potential state of the current-carrying members 11 does not vary.

### Third Modified Example

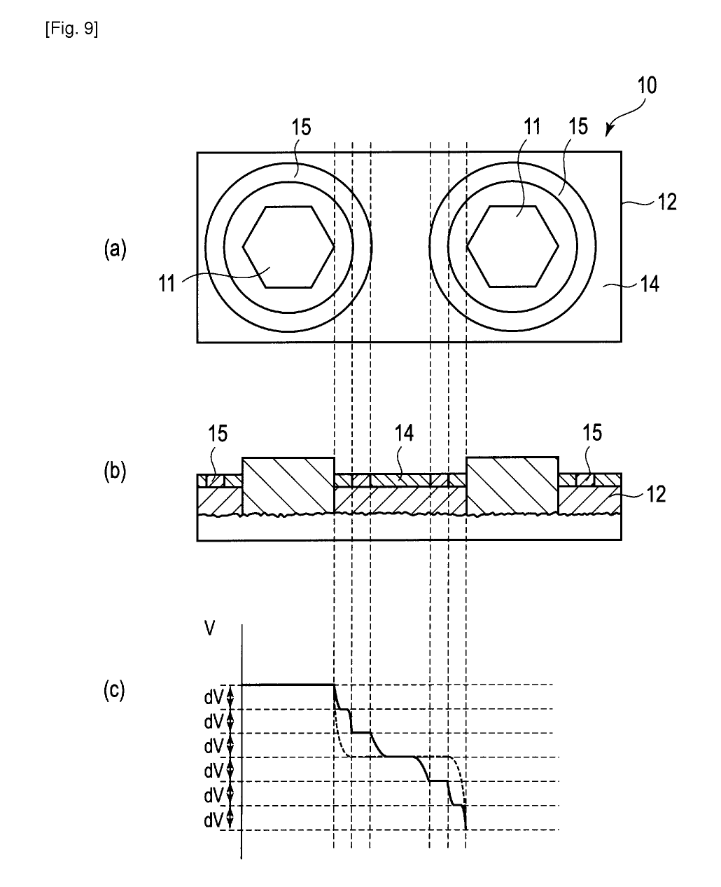

FIG. 8 is an explanatory diagram schematically showing still another modified example of the electrical component 10 according to the first embodiment. In the present modified example, a coating material is coated on each outer edge area of the current-carrying members 11 on the surface of the insulator 12, so as to form the respective resistant bodies 13. Such a coating material to be provided as the resistant bodies 13 has the resistant value R to be appropriately set so that the voltage applied to each area of the ionic contaminant 14 adjacent to the current-carrying members 11 is reduced to the discharge starting voltage Vs or less, as described above. As a coating material, a coating material having electrical conductivity may be used. For example, a coating material including metal powder may be applied. In such a case, a coating material to be used preferably includes metal with a low possibility of causing electro-migration.

According to the present modified example, the coating material having electrical conductivity is coated, thereby forming the respective resistant bodies 13. Therefore, since the resistant bodies 13 can be formed by a simple method, the improvement of insulation durability of the electrical component 10 can be easily achieved.

The regions coated with the coating material for the respective resistant bodies 13 may be limited to the regions of the range widths x as described in the first modified example. Alternatively, the coating material may be provided at only one of the current-carrying members 11 according to the type of the terminal block as described in the third modified example.

### Second Embodiment

FIG. 9 is an explanatory diagram showing a constitution of the electrical component 10 according to the second embodiment. Hereinafter, the constitutions identical to the first embodiment will refer to the same reference numerals, and the explanations thereof will not be repeated. The differences from the first embodiment will be mainly explained below. In the present embodiment, the electrical component 10 is assumed to be a terminal block, and the electrical component 10 includes the three current-carrying members 11 corresponding to three phases. Although the following is an explanation of the electrical component 10 and mainly a pair of the current-carrying members 11 adjacent to each other as main parts for the sake of convenience, the similar consideration may be also applied with respect to the relationship with the remaining current-carrying member 11.

The electrical component 10 according to the present embodiment is composed of the current-carrying members 11, the insulator 12, and electrical conductors 15. Each of electrical conductors 15 is serving as a voltage distribution unit (voltage distribution means). The electrical conductors 15 as one of characteristics of the present embodiment are provided at the peripheries of the current-carrying members 11 on the surface of the insulator 12. More specifically, the electrical conductors 15 have a loop shape, and surround the current-carrying members 11 being separated from the peripheries of the current-carrying members 11 by a predetermined distance. The electrical conductors 15 are configured to have an annular shape. The electrical conductors 15 adhere to the surface of the insulator 12 by an adhesive agent, for example, so as to be fixed to the surface of the insulator 12. Alternatively, the electrical conductors 15 may be formed by insert molding into the insulator 12 together with nuts composing the current-carrying members 11, so as to be fixed to the surface of the insulator 12.

In FIG. 9, the electrical component 10 includes one electrical conductor 15 for each current-carrying member 11. However, an arbitrary number of the electrical conductors 15 may be provided according to the following concept. Namely, the number n of the electrical conductors 15 provided at the current-carrying members 11 is derived based on the voltage applied between the pair of the current-carrying members 11 adjacent to each other, and the discharge starting voltage Vs derived by use of a Paschen's law. The discharge starting voltage Vs derived by use of a Paschen's law is represented by the following formula.

$${V}_{S} = \frac{B \times p \times x 1}{ln \frac{A \times p \times x 1}{ln ( 1 + \frac{1}{Gma} )}} \qquad [ Math . 7 ]$$

In the mathematical formula, p represents atmospheric pressure, and A and B represent constants to determine a collisional ionization coefficient of gas. In addition, Gma represents a secondary electron emission coefficient, and x1 represents a distance between members having a potential difference.

Thus, the number n of the electrical conductors 15 is calculated by the following formula by use of the voltage applied between the current-carrying members 11 and the discharge starting voltage Vs.

$$n = \frac{V}{Vs \times 2} \qquad [ Math . 8 ]$$

In the case in which the number n is not a natural number, an immediate natural number that is larger than n is preferably applied to the number n of the electrical conductors 15.

The distance x1 as a parameter shown in the mathematical formula 7 is determined based on a behavior of the deliquescing ionic contaminant 14 generated on the surface of the insulator 12. However, the behavior of the deliquescing ionic contaminant 14 is greatly influenced depending on an environment under which the insulator 12 is present. Thus, it may be difficult to unambiguously determine the distance x1. In such a case, the number n may be calculated by the following formula in view of the lower limit of the discharge starting voltage Vs that is approximately 300 V.

$$n = \frac{V}{300 \times 2} \qquad [ Math . 9 ]$$

In the case in which the value calculated by the mathematical formula 9 is not a natural number, an immediate natural number that is larger than n is preferably applied to the number n of the electrical conductors 15.

According to the present embodiment, as described above, the electrical conductors 15 are provided under the condition in which each of the periphery applied voltages dV applied to the respective peripheries of the current-carrying members 11 and the electrical conductors 15 on the surface of the insulator 12 is set to the discharge starting voltage Vs or less.

Due to such a constitution, the electrical conductors 15 distribute the voltage applied between the pair of the current-carrying members 11 adjacent to each other on the surface of the insulator 12 (voltage distribution means). Thus, as shown in FIG. 9(c), each of the periphery applied voltages applied to the respective peripheries of the current-carrying members 11 and the electrical conductors 15 is set to the discharge starting voltage Vs or less. In other words, each of the potential differences (periphery applied voltages dV) distributed on the surface of the insulator 12 can be reduced to the discharge starting voltage Vs or less. Accordingly, since the effect of the electric field reduction can be sufficiently obtained, an electric discharge caused on the surface of the insulator 12 can be suppressed effectively. Therefore, the improvement of insulation durability of the electrical component 10 can be achieved due to the effective prevention of an electric discharge caused on the surface of the insulator 12.

According to the present embodiment, one or more of the electrical conductors 15 are provided concentrically with the respective current-carrying members 11. The number n of the electrical conductors 15 is determined based on the voltage V applied between the pair of the current-carrying members 11 adjacent to each other on the surface of the insulator 12 and the discharge starting voltage Vs.

Due to such a constitution, since the number n of the electrical conductors 15 is set appropriately, each of the potential differences (periphery applied voltages dV) distributed on the surface of the insulator 12 can be reduced to the discharge starting voltage Vs or less. Therefore, an electric discharge caused on the surface of the insulator 12 can be suppressed effectively.

Note that, the electrical conductors 15 according to the present embodiment may have at least electrical conductivity, and may be resistant bodies having predetermined electrical resistance. Even when the electrical conductors 15 function as resistant bodies, the effect of the electric field reduction can be obtained sufficiently. Accordingly, an electric discharge caused on the surface of the insulator 12 can be prevented effectively.

The following is an explanation of a modified example of the electrical conductors 15 of the electrical component 10 according to the second embodiment.

### Fourth Modified Example

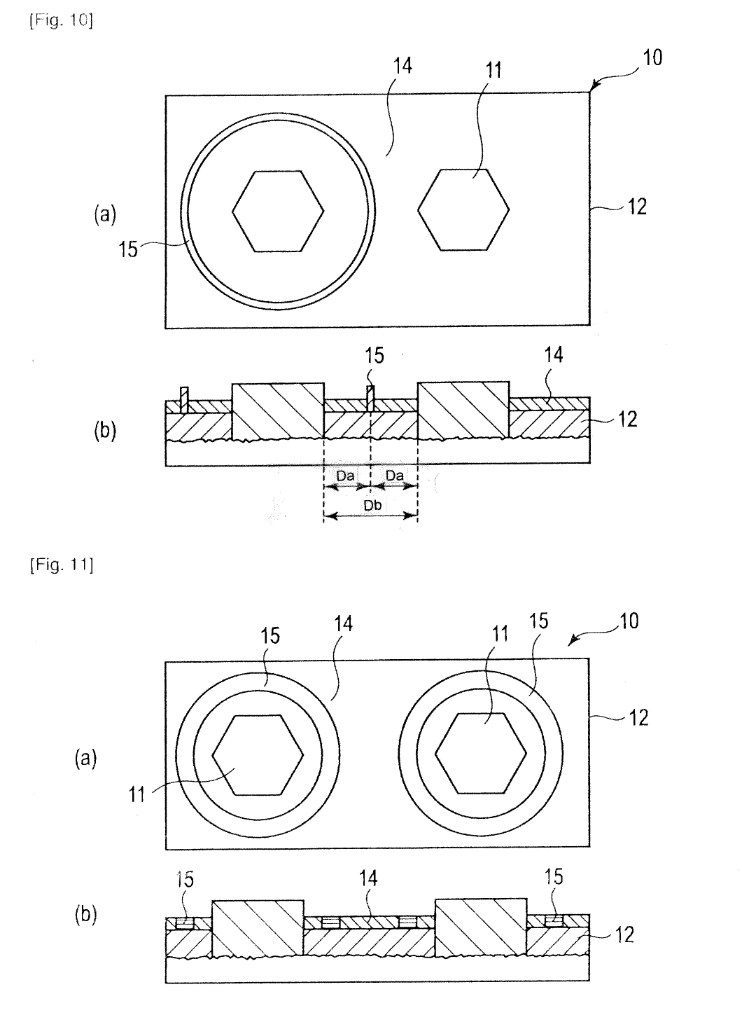

FIG. 10 is an explanatory diagram schematically showing a modified example of the electrical component 10 according to the second embodiment. In the present modified example, the electrical conductor 15 is composed of a metallic cylindrical member. The electrical conductor 15 is provided so as to surround the current-carrying member 11 by means of insert molding, and is embedded in the insulator 12 in such a manner that the end portion of the electrical conductor 15 protrudes from the surface of the insulator 12. In this case, a protrusion height of the electrical conductor 15 is preferably set to be lower than a height of the current-carrying member 11.

In the present example, the electrical conductor 15 is provided at only one of the pair of the current-carrying members 11. One of the pair of the current-carrying members 11 to be provided with the electrical conductor 15 is preferably the current-carrying member 11 at a high potential side. Such a layout is based on the knowledge that an electric discharge is easily caused at the current-carrying member 11 at a high potential side compared with the current-carrying member 11 at a low potential side.

As shown in FIG. 10(b), each distance Da between the respective current-carrying members 11 and the electrical conductor 15 is set to correspond to each other in the shortest distance between the pair of the current-carrying members 11 adjacent to each other. When the distance (shortest distance) between the current-carrying members 11 is defined as “Db”, the distance Da is calculated by the following formula.

$$Da = \frac{Db}{N + 1} \qquad [ Math . 10 ]$$

In the mathematical formula, N represents the number of the electrical conductors 15 present between the pair of the current-carrying members 11. When each of the pair of the current-carrying members 11 is provided with the electrical conductor 15, each distance between the current-carrying members 11 and the electrical conductors 15 and the distance between the electrical conductors 15 adjacent to each other are preferably set to correspond to each other.

According to the present modified example, the electrical conductors 15 are provided so that each distance Da between the current-carrying members 11 and the electrical conductors 15 (depending on the situation, the distance between the cylindrical electrical conductors 15 adjacent to each other) corresponds to each other. Due to such a constitution, since a local dried state can be prevented, a local increase and decrease of the respective periphery applied voltages applied to the respective peripheries of the current-carrying members 11 and the electrical conductors 15 can be prevented. Therefore, each of the periphery applied voltages dV can be reduced to the discharge starting voltage Vs or less, and an electrical discharge caused on the surface of the insulator 12 can be prevented effectively. In addition, the electrical conductor 15 is composed of a metal cylindrical member, so that the electrical conductor 15 can be provided in the insulator 12 with a simple structure.

Moreover, since the electrical conductor 15 is provided at only one of the current-carrying members 11, an increase in cost associated with an increase in number of components can be suppressed. Further, an electrical discharge adjacent to the current-carrying member 11 at a high potential side at which an electrical discharge is particularly easily caused can be suppressed effectively.

In the above-described example, the electrical conductor 15 is provided at only one of the current-carrying members 11. However, in the case in which the electrical conductor 15 is provided at each of the pair of the current-carrying members 11, the electrical conductors 15 are preferably provided more at the current-carrying member 11 at a high potential side at which an electrical discharge is particularly easily caused. Due to the increase in number of the electrical conductors 15, an electrical discharge adjacent to the current-carrying member 11 at a high potential side at which an electrical discharge is particularly easily caused can be suppressed effectively.

While, in the case in which the electrical conductor 15 is provided at only one of the current-carrying members 11 at a high potential side, the present modified example is effective with respect to the electrical component 10, such as a terminal block for connecting DC, in which a potential state of the current-carrying members 11 does not vary.

### Fifth Modified Example

FIG. 11 is an explanatory diagram schematically showing another modified example of the electrical component 10 according to the second embodiment. In the present modified example, a coating material is coated on the respective peripheries of the current-carrying members 11 on the surface of the insulator 12, so as to form the annularly-shaped electrical conductors 15. The number of the coating materials to be provided as the electrical conductors 15 is appropriately set so that the voltage applied to the peripheries of the current-carrying members 11 is reduced to the discharge starting voltage Vs or less, as described above. As for such a coating material, a coating material having electrical conductivity may be used. For example, a coating material including metal powder may be applied. In such a case, a coating material to be used preferably includes metal with a low possibility of causing electromigration.

According to the present modified example, the coating material having electrical conductivity is coated so as to form the electrical conductors 15. Due to such a constitution, the electrical conductor 15 can be formed by a simple method, so that the improvement of insulation durability of the electrical component 10 can be easily achieved.

Although the electrical component according to the embodiments of the present invention has been described, the invention is not limited to the foregoing embodiments, and various modifications may be made within the scope of the invention. For example, the electrical component is not limited to the terminal block, and the present invention may be applied to various purposes as long as the electrical component includes the current-carrying members in the insulator, such as a terminal provided in a circuit substrate.

The entire contents of a Japanese Patent Application No. P2010-133535 with a filing date of Jun. 11, 2010 and a Japanese Patent Application No. P2011-057353 with a filing date of Mar. 16, 2011 are herein incorporated by reference.

### INDUSTRIAL APPLICABILITY

The present invention is characterized in that the voltage distribution unit is provided in a periphery of at least one of the current-carrying members 11 on a surface of the insulator 12. The voltage distribution unit distributes a voltage applied to the surface of the insulator 12 between a pair of the current-carrying members 11 adjacent to each other, so that a potential difference distributed on the surface of the insulator 12 is set to a discharge starting voltage or less. Therefore, an electric field adjacent to the current-carrying members can be reduced. Accordingly, an electric discharge caused on the surface of the insulator can be prevented, and therefore, insulation durability of the electrical component can be improved. Therefore, the electrical component according to the present invention is industrially applicable.

### REFERENCE SIGNS LIST

1 Electric motor

2 Stator

3 Rotor

4 Case

5 Coil lead wire

10 Electrical component

11 Current-carrying member

12 Insulator

13 Resistant body

14 Ionic contaminant

1. An electrical component, comprising:
two or more current-carrying members through which current can pass;
an insulator that holds the respective current-carrying members in an insulating state; and
a resistant body provided in a periphery of at least one of the current-carrying members on a surface of the insulator,
wherein the resistant body has a resistant value including a condition in which a periphery applied voltage applied to a periphery of the resistant body on the surface of the insulator is set to a discharge starting voltage or less.

2. The electrical component according to claim 1, wherein the resistant body is provided on the surface of the insulator, so as to surround the periphery of the at least one of the current-carrying members.

3. The electrical component according to claim 1, wherein a range width of the resistant body is determined so that the periphery applied voltage is set to the discharge starting voltage or less in a shortest distance between a pair of the current-carrying members adjacent to each other.

4. The electrical component according to claim 3, wherein the resistant body is provided at a current-carrying member at a high potential side of the pair of the current-carrying members adjacent to each other.

5. The electrical component according to claim 1, wherein the resistant body is formed in such a manner that a coating material having electrical conductivity is coated.

6. An electrical component, comprising:
two or more current-carrying members through which current can pass;
an insulator that holds the respective current-carrying members in an insulating state; and
at least one electrical conductor that surrounds at least one of the current-carrying members at a position separated from a periphery of the at least one of the current-carrying members on a surface of the insulator,
wherein the at least one electrical conductor is provided under a condition in which each periphery applied voltage applied to respective peripheries of the current-carrying members and the at least one electrical conductor on the surface of the insulator is set to a discharge starting voltage or less.

7. The electrical component according to claim 6,
wherein one or more electrical conductors are provided concentrically with the at least one of the current-carrying members, and
a number of the electrical conductors is determined based on a voltage applied between a pair of the current-carrying members adjacent to each other on the surface of the insulator and the discharge starting voltage.

8. The electrical component according to claim 6, wherein the at least one electrical conductor is arranged in such a manner that each distance between the current-carrying members and the at least one electrical conductor corresponds to each other in a shortest distance between the pair of the current-carrying members adjacent to each other.

9. The electrical component according to claim 8, wherein the electrical conductor is provided at each of the pair of the current-carrying members, and the respective electrical conductors are arranged in such a manner that each distance between the current-carrying members and the electrical conductors and a distance between the electrical conductors adjacent to each other correspond to each other.

10. The electrical component according to claim 6, wherein the electrical conductors are provided more at one current-carrying member at a high potential side than another current-carrying member at a low potential side of the pair of the current-carrying members adjacent to each other.

11. The electrical component according to claim 6, wherein the at least one electrical conductor is formed in such a manner that a metal cylindrical member is embedded in the insulator.

12. The electrical component according to claim 6, wherein the at least one electrical conductor is formed in such a manner that a coating material having electrical conductivity is coated.

13. The electrical component according to claim 6, wherein the at least one electrical conductor includes a resistant body.

14. An electrical component, comprising:
two or more current-carrying member through which current can pass;
an insulator that holds the respective current-carrying members in an insulating state; and
a voltage distribution unit provided in a periphery of at least one of the current-carrying members on a surface of the insulator,
wherein the voltage distribution unit distributes a voltage applied to the surface of the insulator between a pair of the current-carrying members adjacent to each other, so that a potential difference distributed on the surface of the insulator is set to a discharge starting voltage or less.

15. An electrical component, comprising:
two or more current-carrying means for conducting current;
insulating means for holding the respective current-carrying means in an insulating state; and
voltage distribution means for distributing a voltage applied to the surface of the insulator, which provided in a periphery of at least one of the current-carrying means on a surface of the insulating means,
wherein the voltage distribution means distributes a voltage applied to the surface of the insulating means between a pair of the current-carrying means adjacent to each other, so that a potential difference distributed on the surface of the insulating means are set to a discharge starting voltage or less.
